(19) United States
(12) Patent Application Publication
(10) Pub. No.: US 2006/0157941 A1
(43) Pub. Date: Jul. 20, 2006

(54) Seal for assembling fluid-circuit tubular elements

(76) Inventors: Jean-Pierre Vitel, Regnieville (FR); Jean-Francois Schmuck, Tonnoy (FR); Philippe Renard, Fleville (FR); Didier Lescot, Toul (FR)

Correspondence Address: SUGHRUE MION, PLLC, 2100 PENNSYLVANIA AVENUE, N.W., SUITE 800, WASHINGTON, DC, 20037, US

(21) Appl. No.: 10/470,905

(22) PCT Filed: Jan. 31, 2002
(86) PCT No.: PCT/FR02/00381

§ 371 Date: Jan. 6, 2004

(30) Foreign Application Priority Data
Feb. 1, 2001 (FR) 01/01371

(51) Int. Cl. F16L 21/02; F16L 17/00

(52) U.S. Cl. 277/602

(57) ABSTRACT

The invention relates to an annular seal used for the telescopic mounting of a male end (10) of a first tubular element (1) in a socket (20) of a second tubular element (2). Said seal comprises an elastically-deformable annular body (3) designed to be threaded around the outer surface of the male end (10) and an anchoring lug (4) that only extends over part of the length of the body projecting radially around the latter and designed to be housed in an anchoring groove (25) disposed in the inner surface of the socket. At least one part of the lug (4) is made from a reinforcing material having a hardness greater than that of the body (3). Said seal is characterised in that the reinforcing material is located radially at a distance from the inner surface (32) of the body (3). Use: water supply and disposal networks.

The present invention concerns a seal for sealing, in a fluid circuit, a telescopic mounting between respective end regions in a mutual socketing relationship of a first and a second tubular element, the end region of the first element called “male end” having an outer surface that is approximately smooth, and that of the second element called “socket” having an inner surface provided with an anchoring groove, the seal being designed to be inserted and radially compressed between the outer surface of the male end and the inner surface of the socket.

Such an annular seal can be implemented to seal the joint between the respective fitted ends of two pipes, or of one pipe and a coupling sleeve, for example of cast iron, steel, or synthetic material, and particularly to seal the mounting of pipeline elements of ductile cast iron used in the construction of potable water supply or waste water networks.

In order to remedy the disadvantages of seals having a body designed to be inserted and radially compressed between the fitted end regions of two tubular elements, and a rigid collar or a stiffening ring outside the socket intended to be supported against the front face of said socket to prevent the seal from being dragged to the bottom of the socket when the male end is inserted thereinto, and more particularly to their lack of reliability due to the vulnerability of the collar or ring to frontal impacts, seals have been designed comprising a collar or a ring that are also intended to be inserted between the fitted end regions of the two elements and to that end constructed in the form of an anchoring lug extending along part of the length of the body, projecting around the outer surface thereof, designed to be inserted in an anchoring groove made in the inner surface of the socket.

Since all of the seal must be inserted between the two elements, it must be relatively flexible, but this flexibility results in significant risks that the lug may escape from the groove and the seal be dragged toward to bottom of the socket when the male end is inserted into said socket, or it may be expelled out of said socket when the mounting is placed under pressure.

Known, for example, is a seal having an elastically deformable annular body designed to be threaded around the approximately smooth outer surface of the male end and an anchoring lug extending along part of the length of the body, projecting around the outer surface thereof, the body and the lug being made of a single piece of elastomer material with a Shore hardness of about 67°. In spite of this hardness, which requires significant effort to fit the male end into the socket, it is necessary to provide in the inner surface of the socket an appreciably radial stop to hold the seal in the event it is dragged toward the bottom of the socket when the male end is inserted into the socket. This stop is therefore positioned in front of the anchoring groove in the direction going toward the bottom of the socket, but naturally behind the free end of the male end in insertion position.

Also known, by the document DE GM 1 860 424, is a seal having a body and an anchoring lug, having a “rear” part (if reference is made to the direction of fitting the male end into the socket) made of hard rubber to hold the seal in place during the fitting, and a “front” part of flexible rubber the compression of which is intended to ensure the seal of the mounting. However, here again the socket is provided with an internal stop to hold the seal; moreover, the fitting first needs to compress the hard rubber part, thus requiring significant fitting efforts.

Also known, by the document U.S. Pat. No. 2,953,398, is a composite seal of elastomer, reinforced at a rear part of its periphery (with the same convention of direction as mentioned above) to give it sufficient rigidity to prevent its being dragged along axially and having channels or internal recesses to improve its flexibility during the fitting. Although this seal is made rigid, particularly in its anchoring part, it is not guaranteed to be held in place and the socket once again is furnished with an internal stop to prevent its being pushed back toward the bottom of the socket when the male end is inserted. In addition, the mounting is still difficult because of the reinforcement of the seal on a large part of its periphery, and more particularly because of its inner surface coming into sealing contact with the male end.

Moreover, the document FR 2 512 917 concerns a radial compression seal of a mono-hardness material provided with parallelepiped cells with square cross sectional shape. Although the cells give the seal greater flexibility, allowing the mounting effort to be reduced, this solution is still not sufficient because, since the seal is not rigidified, it requires the use of a relatively hard elastomer to provide the anchoring, and the hardness of the elastomer increases the effort required for the mounting.

A purpose of the invention is to remedy these disadvantages, and to that end concerns an annular seal intended to be inserted and radially compressed between the outer surface of a male end of a first tubular element and the inner surface of the socket of a second tubular element, this seal having an elastically deformable annular seal body designed to be threaded around the outer surface of the male end and an anchoring lug designed to be housed in an anchoring groove disposed in the inner surface of the socket, the body being delimited by two axial end surfaces connected by an outer surface and by an inner seal surface and the anchoring lug only extending over a part of the length of the body, projecting radially around the outer surface of said body, and at least all of the free outer surface of the lug being made of a reinforcing material having a hardness greater than that of the body, which seal is characterized in that the reinforcing material is situated radially away from the inner surface of the seal body.

Because of this characteristic, the reinforcing material has no contact with the male end whose outer surface, during the mounting, comes into contact only with the inner surface of the seal body, said body being made of an easily compressible flexible material, the mounting effort is thus significantly limited.

In addition, because the anchoring lug is rigidified by a reinforcing material of a hardness greater than that of the flexible body, the seal is then effectively anchored in the socket without the need to provide an additional stop surface inside the inner surface of the socket. The lug is therefore effectively held in the anchoring groove of the socket in both axial directions, that is, during the insertion of the male end, when the dragging of the seal toward the bottom of the socket is prevented, as well as when it is placed under pressure, when the expulsion of the seal out of the socket, from the effect of forces tending to separate the tubular elements, is prevented.

Moreover, the seal can have one or more of the following characteristics:

the anchoring lug extends axially exclusively between the two axial outer surfaces of the body, these two outer surfaces being free surfaces;

the entire lug is made of a reinforcing material having a hardness greater than that of the body;

the lug has a part forming a core, made of the same material as the body and a reinforcing part that is made of a material having a hardness greater than that of the body and which constitutes an envelope-forming part for the lug;

the envelope-forming part has vanes;

the vanes extend radially into the core forming part;

the vanes are tilted inside the core;

the reinforcing material having a hardness greater than that of the body also has a melting point greater than that of the body;

the body is made of an elastomer material or elastomeric polymer;

the body is made of a material having a hardness within the range of 40° Shore to 60° Shore;

the reinforcing material, having a hardness greater than that of the body, is a synthetic material;

the synthetic material is a thermoplastic material;

the thermoplastic material is a polyamide;

the body has cells;

the cells are in the shape of a truncated pyramid;

the truncated pyramids have a rhomboidal cross section;

one part of the outer surface of the body is a sealing surface;

the body, when it is not subject to exterior stress, has an outer surface of generally cylindrical shape;

the body, when it is not subject to stress, has a conical inner surface;

the body, when it is not subject to stress, has at least one outer conical surface;

the body has at least an outer surface into which the hollow cells in the body open out; and

the lug has a longitudinal cross section generally trapezoidal in shape.

Other characteristics and advantages of the invention will become apparent from the following description, the forms of embodiment of the invention being given by way of non-limiting examples and illustrated by the attached drawings in which:

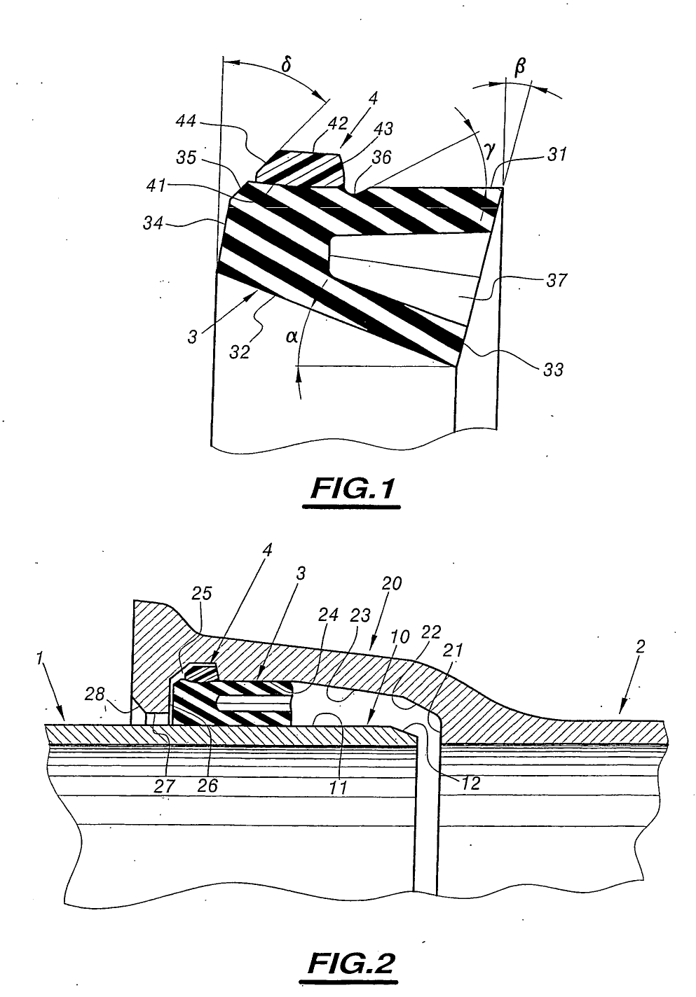

FIG. 1 is a diagrammatical longitudinal cross section of a part of a seal according to the invention in a first form of embodiment,

FIG. 2 is a diagrammatical longitudinal cross section of a part of a telescopic mounting of two pipe elements sealed by the seal of FIG. 1,

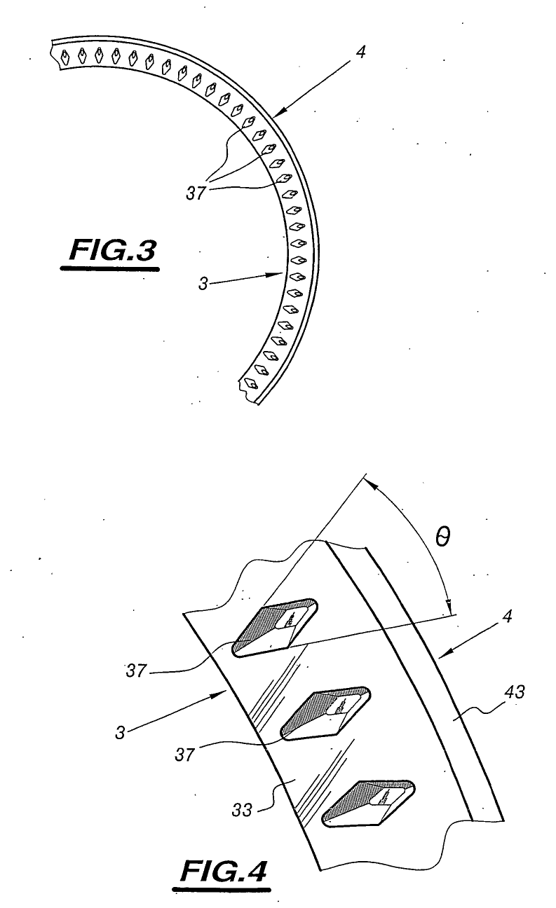

FIG. 3 is a partial front view of the seal of FIG. 1,

FIG. 4 is a partial front view showing details of the seal of FIG. 1,

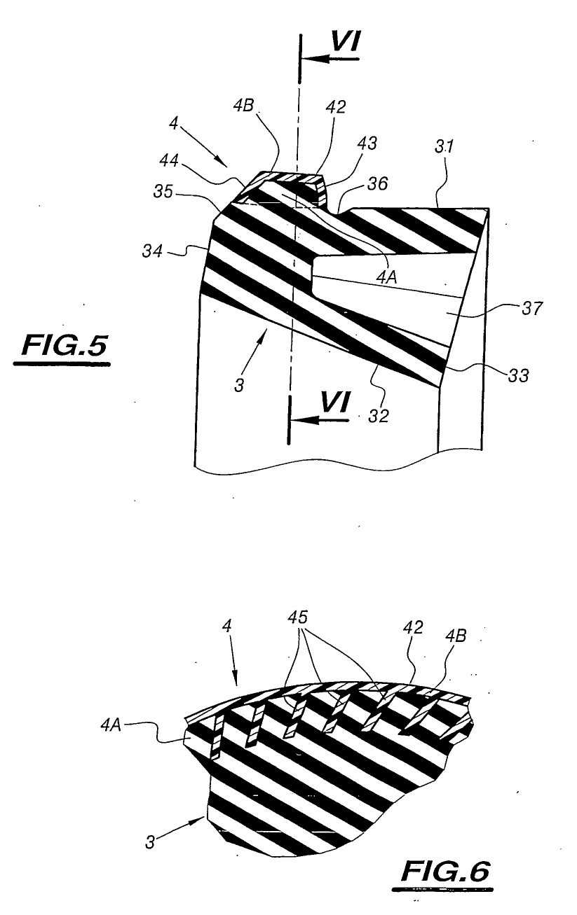

FIG. 5 is a diagrammatical longitudinal cross section of a part of a seal according to the invention in a second form of embodiment, and

FIG. 6 is a partial cross section of the seal of FIG. 5 along the line VI-VI of that figure.

The annular seals illustrated by the figures are intended to seal, in a fluid circuit, a telescopic mounting of respective end regions of two tubular elements fitted to each other; these tubular elements, for example, can be cylindrical pipes for waste water, one of which pipes has an end forming a male end and the other has an end in the form of a socket forming a female end or socket, and although this is not required, this is the example that will be chosen for the present description in order to simplify it.

Thus the first pipe 1 has an end forming a male end 10 which is intended to be fitted into an end region of the second pipe 2 forming a socket 20. In the selected example, respective longitudinal channels of approximately the same diameter run through the pipes 1, 2.

The male end 10 of the first pipe 1, intended to be mounted in the socket 20 of the second pipe 2, has an outer surface of generally cylindrical shape 11 with circular cross section which is approximately smooth, provided at its free end with a beveled section 12.

The socket 20 into which the male end 10 is intended to be mounted has an inner surface the bottom of which has an appreciably radial retaining collar 21 intended to serve as stop for the free end of the male end, and going toward the free end of the socket, a first conical section 22 flaring toward this free end and with taper approximately equal to that of the beveled section 12, a section conical section 23 also flaring toward this end but of slightly less taper, a cylindrical section 24, and a succession of sections (conical, cylindrical, conical), forming a groove 25 extending from the cylindrical section 24 toward the outer peripheral wall of the socket 20 as well as toward its free end without reaching it; the groove 25 ends at a nearly radial retaining collar 26 from which there extend, going toward the free end of the socket 20, a cylindrical section 27 and a conical section 28 flaring toward this free end; the conical section of the groove 25, which extends from the cylindrical section 24, has a very large taper and constitutes a retaining collar, while the opposite conical section, which ends in the retaining collar 26, is sloped approximately 40 degrees.

The diameters of the second conical section 23 and the cylindrical section 24 are markedly larger than that of the outer surface 11 of the male end 10 so as to constitute a chamber for the insertion of the seal, while the diameter of the cylindrical section 27 is only just larger so as to prevent the ejection of the seal when the mounting is placed under fluid pressure.

The annular seal illustrated by FIGS. 1 to 4 and of which FIG. 1 shows diagrammatically a portion in longitudinal cross section, in the absence of any exterior stress has an annular seal body 3 that is elastically deformable, designed to be threaded around the outer surface of the male end 10, and an annular anchoring lug 4 extending only along a part of the length of the body 3, projecting radially around the outer surface of said body.

More specifically, the annular body 3 has an outer surface 31 the general shape of which is approximately cylindrical, one part of which provides the seal with the inner surface of the socket 20 and the diameter of which is appreciably equal to that of the cylindrical section 24 of the inner surface of the socket, and a conical inner surface 32 sloped at an angle a of about 20 degrees with reference to the direction in which the outer surface extends, this inner surface 32 of the body 3 also constituting the inner surface of the seal; the outer surface and the inner surface are connected by conical annular surfaces of axial end 33, 34 sharply sloped in the same direction, with respect to the outer surface 31; the direction of slope of these end surfaces 33, 34 is such that in longitudinal cross section, the angles of one 33 of the end surfaces respectively with the outer surface 31 and with the inner surface 32 are two acute angles while the angles of the other end surface 34 respectively with the outer surface 31 and with the inner surface 32 are two obtuse angles, the first of these obtuse angles, however, being broken by a chamfer 35; by way of example, the angle β of the end surface 33 defining acute angles, with the perpendicular plan to the outer surface, is about 10 degrees; the outer surface 31 has, approximately at mid-length, an annular groove 36 having a rounded wall toward the obtuse angles, and toward the acute angles a conical wall sloped at an angle y of about 27 degrees with reference to the outer surface.

The annular anchoring lug 4 is joined to the body 3 between the groove 36 and the chamfer 35, in an area of the body 3 that is slightly concave. The lug 4 is therefore located completely away from the inner sealing surface 32 and extends in outer radial projection around the outer surface 31 of the body 3; axially, the lug 4 extends between the two axial end surfaces 33, 34 of the flexible body 3, these end surfaces being free surfaces, that is, surfaces not covered by another material. As a result of the presence of the anchoring lug 4, the body 3 can be comprised of an elastically deformable material such as an elastomer or a relatively flexible elastomeric polymer with a hardness between 40° and 60° Shore (preferably around 50° Shore). In order to increase the flexibility of the body, it is possible to produce it so that it has cells 37 opening out into the annular end surface 33; these cells can be distributed in this end surface around the circumference extending approximately at equal distance from the outer surface 31 and from the inner surface 32; each cell 37 here has the shape of a truncated pyramid with an approximately rhombus shaped transverse cross section the large diagonal of which extends radially with reference to the body 3, while the edges of the truncated pyramid corresponding to this diagonal are approximately parallel to the generatrices respectively of the outer surface 31 and of the inner surface 32 and converge toward to outer surface 34 having a chamfer 35. Preferably, the diagonals of the rhombus of the transverse cross section of the cells are such that the large radial diagonal constituting the height of the rhombus is more than double the small diagonal constituting its width, which makes it possible to uniformly distribute the radial compression of the body 3 over the whole periphery and thus to achieve a uniform tightening and seal of the body 3 on the male end 10, and more particularly to the right of the radial diagonals of the rhombuses; the tops of the rhombus are slightly rounded so as not to generate a sharp truncated pyramid edge that could tear the body; the acute angle θ formed by the sides of the rhombus is around 45 degrees (FIGS. 3 and 4).

The annular anchoring lug 4 has a longitudinal cross section that is generally trapezoidal in shape the large base 41 of which, slightly convex, is united to the body 3 by the concave area of said body extending between the groove 36 and the chamfer 35, and the small base 42 is approximately parallel to the generatrices of the outer surface 31 so that the outer surface of the lug 4 is approximately cylindrical. The sloped sides of the trapezoid are one slightly convex side 43 having approximately the same slope as the conical section of the groove 25 of the socket 20 extending from the side of the cylindrical section 24 of said socket, and one side 44 located beside the chamfer 35 and sloped at an angle δ of about 40° with reference to the perpendicular plane at the outer surface 31 of the body 3. The full ring comprising the anchoring lug 4 is made of a synthetic reinforcing materials, for example a thermoplastic such as a polyamide, adhered to the flexible materials comprising the body 3, having a melting point greater than that of this flexible material. The ring, however, should be flexible enough to allow the deformation of the seal (and thus its own deformation) when the seal is installed in the socket. This ring can have one or more notches (not shown) to improve its deformability.

To manufacture the seal, the ring intended to form the lug 4 is placed at the bottom of a mold the shape of which corresponds to the desired shape of the seal, then the elastomer is injected in the mold. Since the melting point of the material comprising the ring is greater than that of the elastomer, the ring does not melt during the injection molding of the body and adheres to the elastomer.

As a variation (FIGS. 5 and 6), the annular anchoring lug 4 has approximately the same external aspect as that of FIGS. 1 to 4 but is composed of two parts, that is, a core 4A of a single piece with the body 3 and made of the same material, thus of elastomer, and an envelope 4B made of the same materials as the lug 4 of the form of embodiment of FIGS. 1 to 4. Preferably the envelope 4B has vanes 45 extending into the elastomer of the core 4A, so as to confer on the lug the rigidity needed to hold it in the groove 25 of the socket while still preserving enough flexibility to allow a suitable deformation of the seal when it is placed in the chamber defined between the male end 10 and the socket 20, these vanes extending radially, for example, or sloped (FIG. IS 6) with reference to the radial direction to facilitate the compression of the lug when the groove 25 has a volume that is too confined. Because the lug has the same outer shape as in FIGS. 1 to 4, the envelope 4B has, in addition to the vanes 45, a cylindrical wall corresponding to the small base 42 of the trapezoid, extending between two conical walls corresponding to the sloped sides 43, 44.

Naturally, the forms described above are those, unless otherwise indicated, of a seal that is not subject to any external stress.

To assemble the mounting, the seal is inserted into the socket 20, in the absence of the male end 10, through the free end of the socket, and to do this the seal is deformed so as to be able to insert the lug 4 into the groove 25 of the socket 20. Then the male end 10 is inserted into the assembly, using force to deform the body 3 of the seal so that its inner surface 32 takes a cylindrical shape coaxial to its outer surface 31, and it pressed against the outer surface 11 of the male end 10 while the outer surface 31 of the seal is pressed against the cylindrical section 24 of the inner surface of the socket, which ensures the seal between the pipes 1, 2.

The rigidification of just the anchoring lug by a synthetic material away from the inner surface of the seal, and thus from the outer surface of the male end, makes it possible to limit the mounting effort and ensures that the lug is held in place in its anchoring groove of the socket. Moreover, the fact that the whole free outer surface of the anchoring lug is made of a reinforcing material prevents the seal from being dragged toward the bottom of the socket when the male end is inserted, as well as preventing the ejection of the seal out of the socket from the action of the pressure of the fluid circulating in the pipes.

Furthermore, because of the effectiveness of the anchoring provided by the composite seal according to the invention, it is possible to eliminate the stop at the bottom of the socket, thus making it possible to shorten the socket and accomplish a gain in material, cast iron in this instance, of the pipes.

The cells 37 disposed in the body 3 give the seal increased flexibility and decrease still more the effort required for mounting.

Comparative tests between a seal such as the one shown in FIG. 1 and a seal of the same geometry made entirely of elastomer confirm that the combination of an anchoring lug made of synthetic material (allowing the use, for the seal body, of an elastomer or a flexible elastomeric polymer) with a body honeycombed with cells considerably reduces the effort required for mounting, particularly when there is very little clearance between the male end 10 and the socket 20, which makes it possible to use a male end the free end of which is only slightly beveled or even without any bevel.

In addition:

the cells promote the autoclave effect of the seal under the action of the internal pressure of the fluid circulating in the piping system, because the seal then performs much like a lip joint: the greater the fluid pressure that penetrates into the cells, the greater the pressure of the elastomer against the outer surface of the male end, thus ensuring excellent performance at high internal pressures (more than 50 bars); moreover, because of the autoclave effect, the seal fulfills its sealing function even when the internal pressure is low, unlike a non-hollowed compression body seal of the same type subjected to an identical rate of compression and used for identical clearance between the mounted tubular elements;

the pyramid shape of the cells makes it possible to have less elastomer to compress in the compression part of the body near the bottom of the socket, compared to the parallelepiped cells, which contributes to decreasing even more the effort needed for mounting;

the cells improve the moldability of the seal, because the time of the cooling time of the elastomer during the molding process are reduced because of the smaller volume of elastomer to cool, which makes it possible to reduce manufacturing costs;

the cells facilitate the factory pre-lubrication of the inner conical surface of the seal coming in contact with the male end during mounting, by means of a material with strong lubricating power and low coefficient of friction compatible with the elastomer, such as silicone grease or polytetrafluoroethylene for sanitation piping, deposited as a film in a thickness of a few micrometers.

as a result of the cells, the specific pressure at the lubricating film is reduced during the mounting of the male end, which prevents the film form being scraped away; in the absence of cells, it would be necessary for an operator to crease the seal and the male end on the construction site, in the trench (which is awkward and dangerous for the operator), using grease from a conventional can, with all the difficulties that involves, particularly because of dirt being incorporated in the film of grease.

1. Annular seal intended to be inserted and radially compressed between the outer surface of a male end (10) of a first tubular element (1) and the inner surface of the socket (20) of a second tubular element (2), this seal having an elastically deformable annular seal body (3) designed to be threaded around the outer surface of the male end (10) and an anchoring lug (4) designed to be housed in an anchoring groove (25) disposed in the inner surface of the socket (20), the body (3) being delimited by two axial end surfaces (33, 34) connected by an outer surface (31) and by an inner seal surface (32) and the anchoring lug (4) only extending over a part of the length of the body (3), projecting radially around the outer surface (31) of said body, and at least all of the free outer surface of the lug (4) being made of a reinforcing material having a hardness greater than that of the body (3), which seal is characterized in that the reinforcing material is situated radially away from the inner surface (32) of the seal body (3).

2. Seal according to claim 1, characterized in that the anchoring lug (4) extends axially exclusively between the two axial end surfaces (33, 34) of the body (3), these two end surfaces (33, 34) being free surfaces.

3. Seal according to claim 1 or 2, characterized in that all of the lug (4) is made of a reinforcing material having a hardness greater than that of the body (3).

4. Seal according to claim 1 or 2, characterized in that the lug (4) has one part (4A) forming a core, made of the same material as the body (3), and one part (4B) of reinforcement made of a material having a hardness greater than that of the body (3), and which constitutes an envelope-forming part for the lug.

5. Seal according to claim 4, characterized in that the envelope-forming part (4B) has vanes (45).

6. Seal according to claim 5, characterized in that the vanes (45) extend radially into the core-forming part (4A).

7. Seal according to claim 5, characterized in that the vanes (45) are tilted inside the core (4A).

8. Seal according to any of claims 1 to 7, characterized in that the reinforcing material having a hardness greater than that of the body (3) also has a melting point greater than that of the body.

9. Seal according to any of claims 1 to 8, characterized in that the body (3) is made of an elastomer material or elastomeric polymer.

10. Seal according to any of claims 1 to 9, characterized in that the body (3) is made of a material having a hardness within the range of 40° Shore to 60° Shore.

11. Seal according to any of claims 1 to 10, characterized in that the reinforcing material, having a hardness greater than that of the body, is a synthetic material.

12. Seal according to claim 11, the synthetic material is a thermoplastic material.

13. Seal according to claim 12, characterized in that the thermoplastic material is a polyamide.

14. Seal according to any of claims 1 to 13, characterized in that the body (3) has cells (37).

15. Seal according to claim 14, characterized in that the cells are in the shape of a truncated pyramid.

16. Seal according to claim 15, characterized in that the truncated pyramids have a rhomboidal cross section.

17. Seal according to any of claims 1 to 16, characterized in that one part of the outer surface (31) of the body (3) is a sealing surface.

18. Seal according to any of claims 1 to 17, characterized in that the body (3), when it is not subject to exterior stress, has an outer surface (31) of generally cylindrical shape.

19. Seal according to any of claims 1 to 18, characterized in that the body (3), when it is not subject to stress, has a conical inner surface (32).

20. Seal according to any of claims 1 to 19, characterized in that the body (3), when it is not subject to stress, has at least one outer conical surface (33, 34).

21. Seal according to claim 20, characterized in that the body (3) has at least an outer surface (33) into which the hollow cells (37) in the body open out.

22. Seal according to any of claims 1 to 21, characterized in that the lug (4) has a longitudinal cross section generally trapezoidal in shape.
